(19) United States
(12) Patent Application Publication
(10) Pub. No.: US 2025/0343477 A1
(43) Pub. Date: Nov. 6, 2025

(54) Modulated Bi-Directional Zero Voltage Transient AC/DC Converters

(71) Applicant: Ngoc Hai Tran, Lexington, SC (US)

(72) Inventor: Ngoc Hai Tran, Lexington, SC (US)

(21) Appl. No.: 18/655,097

(22) Filed: May 3, 2024

(51) Int. Cl. H02M 1/00; B60L 53/22; H02M 7/81

(52) U.S. Cl. CPC H02M 1/0058; B60L 53/22; H02M 7/81; B60L 2210/30; B60L 2210/40

(57) ABSTRACT

A zero voltage transient cell comprising (i) one high switching frequency mosfet, (ii) two low switching frequency mosfet or two insulated-gate bipolar transistors, (iii) four diodes, (iv) one capacitor; and (v) one inductor or one additional diode in series with the inductor, which zero voltage transient cell can be used in a bi-directional AC/DC converter with switches and in a method of modulation that causes no switching loss in the conversion of AC to DC or DC to AC. The bi-directional AC/DC converter with the zero voltage transient cell can be used in a vehicle onboard charger.

### FIELD OF THE INVENTION

The invention relates to AC/DC converters and modulation methods.

### BACKGROUND OF THE INVENTION

Some AC/DC converters for electrical apparatus use a transformer in a Zero Voltage Transient (ZVT) cell to adapt to AC/DC operation. Capacitors are connected in parallel with a metal oxide silicon field effect transistor (mosfet). However, these converters cannot deliver power bi-directionally and they do not have a blocking diode to prevent circulation current. Better AC/DC converters are needed without these disadvantages or which have a reduction in such.

### SUMMARY OF THE INVENTION

Certain of the preferred embodiments of this invention integrate Zero Voltage Transient (ZVT) cell embodiments of this invention into novel bi-directional AC/DC converters of this invention.

The ZVT cell embodiments of this invention comprise one high switching frequency mosfet (Ss), two low switching frequency mosfet or insulated-gate bipolar transistors (IGBT) (Sb1 and Sb2), four diodes (Ds1, Ds2, Ds3, Ds4), one capacitor (Cs) and one inductor (Ls) (or in an alternative embodiment, one additional diode in series with one inductor). These ZVT cells are then integrated into the bi-directional AC/DC converters of this invention.

The bi-directional ZVT AC/DC converter embodiments use the ZVT cell embodiments of this invention, which provide soft switching for all the switches of the bi-directional AC/DC converter, eliminating the switching loss. A modified totem-pole modulation technique allows the ZVT cells to operate bi-directionally and the soft switching is achieved in both AC to DC mode, and DC to AC mode. Blocking switches (Sb1 and Sb2) in the ZVT cells prevent short circuits through the ZVT cells during the DC to AC mode. Sb1 and Sb2 turn ON and OFF with the AC-line frequency.

Certain embodiments of this invention also use novel modified totem-pole modulation methods. With a conventional totem-pole modulation method, the leg associated with S₃ and S₄ is operated at low frequency (AC-line frequency). The duty cycle of S₂ jumps from 100% to 0% or from 0% to 100% at the zero-crossing point of the grid voltage.

With the modified totem-pole modulation methods of certain embodiments of this invention, in the positive half line cycle, S₄ keeps ON and S₂ acts as the main switch. In the negative half line cycle, S₂ keeps ON and S₄ acts as the main switch. As a result, there is no duty cycle jumping in the modulation methods of certain embodiments of this invention.

In particularly preferred embodiments of this invention, a ZVT cell for integrating in devices is provided. This ZVT cell comprises (a) one high switching frequency mosfet; (b) two low switching frequency mosfet or two insulated-gate bipolar transistors; (c) four diodes; (d) one capacitor; and (e) one inductor. The ZVT cell is capable of providing soft switching for the devices it is integrated in.

In other particularly preferred embodiments of this invention, another ZVT cell for integrating in devices is provided. This ZVT cell comprises (a) one high switching frequency mosfet; (b) two low switching frequency mosfet or two insulated-gate bipolar transistors; (c) four diodes; (d) one capacitor; and (e) one additional diode in series with one inductor. This ZVT cell is capable of providing soft switching for the devices it is integrated in.

Furthermore, preferred embodiments of this invention include a bi-directional AC/DC converter having switching. The AC/DC converter comprises a ZVT cell. The ZVT cell either comprises: (a) one high switching frequency mosfet; (b) two low switching frequency mosfet or two insulated-gate bipolar transistors; (c) four diodes; (d) one capacitor; and (e) one inductor; or it comprises (a) one high switching frequency mosfet; (b) two low switching frequency mosfet or two insulated-gate bipolar transistors; (c) four diodes; (d) one capacitor; and (e) one additional diode in series with one inductor. In either ZVT cell of this embodiments, the ZVT cell provides soft switching for all of the switches of the bi-directional AC/DC converter with no switching loss. In operation, the AC/DC converter has no duty cycle jumping.

In addition, preferred embodiments of this invention include a method of modulating the converting of AC to DC and DC to AC with a bi-directional AC/DC converter with switching. The method comprises (1) converting AC to DC by (a) inputting AC to the bi-directional AC/DC converter comprising a ZVT cell, the ZVT cell comprising (i) one high switching frequency mosfet, (ii) two low switching frequency mosfet or two insulated-gate bipolar transistors, (iii) four diodes, (iv) one capacitor; and (v) one inductor; and (b) outputting DC, wherein the converting of AC to DC causes no duty cycle jumping and no switching loss in the bi-directional AC/DC converter. The method also comprises (2) converting DC to AC by (a) inputting DC to the bi-directional AC/DC converter comprising a zero voltage transient cell, the ZVT cell comprising (i) one high switching frequency mosfet, (ii) two low switching frequency mosfet or two insulated-gate bipolar transistors, (iii) four diodes, (iv) one capacitor; and (v) one inductor; and (b) outputting AC, wherein the converting of DC to AC causes no duty cycle jumping and no switching loss in the bi-directional AC/DC converter.

Another preferred embodiment includes a method of modulating the converting of AC to DC and DC to AC with a bi-directional AC/DC converter with switching. This method comprises (1) converting AC to DC by (a) inputting AC to the bi-directional AC/DC converter comprising a ZVT cell, the ZVT cell comprising (i) one high switching frequency mosfet, (ii) two low switching frequency mosfet or two insulated-gate bipolar transistors, (iii) four diodes, (iv) one capacitor; and (v) one additional diode in series with an inductor; and (b) outputting DC, wherein the converting of AC to DC causes no duty cycle jumping and no switching loss in the bi-directional AC/DC converter. The method also comprises (2) converting DC to AC by (a) inputting DC to the bi-directional AC/DC converter comprising a zero voltage transient cell, the ZVT cell comprising (i) one high switching frequency mosfet, (ii) two low switching frequency mosfet or two insulated-gate bipolar transistors, (iii) four diodes, (iv) one capacitor; and (v) one additional diode in series with an inductor; and (b) outputting AC, wherein the converting of DC to AC causes no duty cycle jumping and no switching loss in the bi-directional AC/DC converter.

Still another preferred embodiment of this invention includes a vehicle onboard charger comprising a bi-directional AC/DC converter with switching, the bi-directional AC/DC converter comprising a ZVT cell, the ZVT cell comprising (i) one high switching frequency mosfet, (ii) two low switching frequency mosfet or two insulated-gate bipolar transistors, (iii) four diodes, (iv) one capacitor; and (v) one inductor, and wherein the converting of AC to DC and DC to AC causes no duty cycle jumping and no switching loss in the bi-directional AC/DC converter.

Another preferred embodiment of this invention includes a vehicle onboard charger comprising a bi-directional AC/DC converter with switching, the bi-directional AC/DC converter comprising a ZVT cell, the ZVT cell comprising (i) one high switching frequency mosfet, (ii) two low switching frequency mosfet or two insulated-gate bipolar transistors, (iii) four diodes, (iv) one capacitor; and (v) one additional diode in series with an inductor, and wherein the converting of AC to DC and DC to AC causes no duty cycle jumping and no switching loss in the bi-directional AC/DC converter.

Advantages of this invention include: (a) achieving soft-switching at both turning ON and OFF of all the semiconductor devices in the circuit; (b) delivering power bi-directionally, and (c) using no parallel capacitor of the switch.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is a circuit diagram of an embodiment of a ZVT cell of this invention.

FIG. 2 is a circuit diagram of an alternative embodiment of a ZVT cell of this invention.

FIG. 3 is a circuit diagram of an embodiment of a bi-directional ZVT AC/DC converter of this invention, which incorporates the ZVT cell of FIG. 1.

FIG. 4 is a circuit diagram of an alternative embodiment of a bi-directional ZVT AC/DC converter of this invention, which incorporates the ZVT cell of FIG. 2.

FIG. 5 is a circuit diagram relating to the operation of the AC to DC mode of an embodiment of a bi-directional ZVT AC/DC converter of this invention.

FIG. 6 is a diagram relating to the waveforms of the AC to DC mode of an embodiment of a bi-directional ZVT AC/DC converter of this invention.

FIG. 7 is a circuit diagram relating to the operation of the AC to DC mode of an embodiment of a bi-directional ZVT AC/DC converter of this invention.

FIG. 8 is a diagram relating to the waveforms of the AC to DC mode of an embodiment of a bi-directional ZVT AC/DC converter of this invention.

FIG. 9 is a circuit diagram relating to the operation of the DC to AC mode of an embodiment of a bi-directional ZVT AC/DC converter of this invention.

FIG. 10 is a diagram relating to the waveforms of the DC to AC mode of an embodiment of a bi-directional ZVT AC/DC converter of this invention.

FIG. 11 is a circuit diagram relating to the operation of the DC to AC mode of an embodiment of a bi-directional ZVT AC/DC converter of this invention.

FIG. 12 is a diagram relating to the waveforms of the DC to AC mode of an embodiment of a bi-directional ZVT AC/DC converter of this invention

FIG. 13 is a circuit diagram relating to certain embodiments of the bi-directional ZVT AC/DC converters of this invention.

FIG. 14 is a circuit diagram relating to certain embodiments of the bi-directional ZVT AC/DC converters of this invention.

FIG. 15 is a circuit diagram relating to certain embodiments of the bi-directional ZVT AC/DC converters of this invention.

### DETAILED DESCRIPTION OF THE INVENTION

Certain embodiments of this invention integrate a Zero Voltage Transient (ZVT) cell into a bi-directional AC/DC converter.

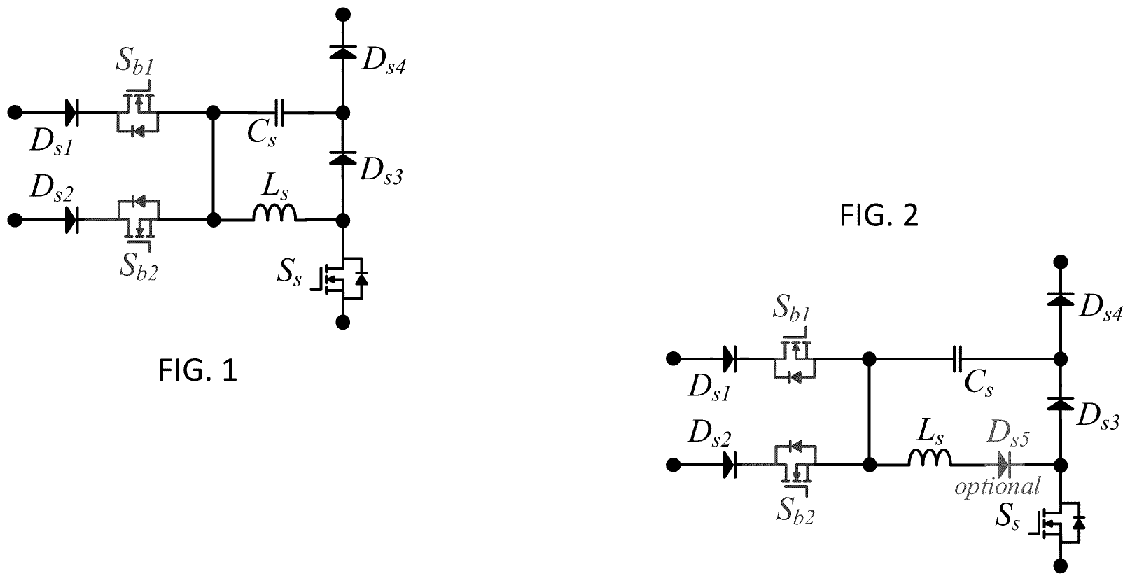

Certain preferred embodiments of ZVT cells (FIG. 1) comprise one high switching mosfet (Ss), two low frequency mosfet or IGBT (Sb1 and Sb2), four diodes (Ds1, Ds2, Ds3, Ds4), one capacitor (Cs) and one inductor (Ls). Alternative ZVT cell embodiments (FIG. 2) use a diode (Ds5) in series with the inductor (Ls).

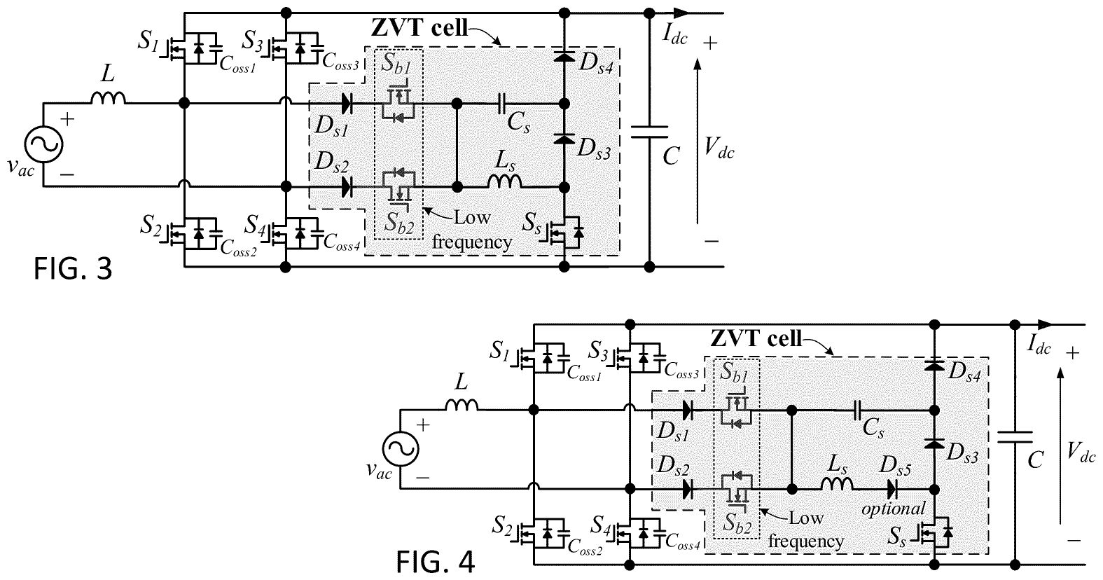

In certain embodiments, the ZVT cells of this invention (e.g., FIGS. 1 and 2) are incorporated into novel bi-directional ZVT AC/DC converters (e.g., FIGS. 3 and 4). The ZVT cells in these embodiments provide soft switching (where switching devices turn off and on at zero or nearly zero voltage or current, minimizing the intersection of their waveforms and reducing switching noise and loss) for all of the switches of the bi-directional AC/DC converter, eliminating (or reducing) switching loss. In certain embodiments, a modulation technique allows the ZVT cells to operate bi-directionally with the soft switching achieved in both AC to DC mode, and DC to AC mode.

In the embodiments of FIGS. 1 and 2, blocking switches (Sb1 and Sb2) in the ZVT cells prevent short circuits through the ZVT cells during the DC to AC mode. Sb1 and Sb2 turn ON and OFF with the AC-line frequency.

Conventional totem-pole (so named for the vertical positioning of two switches) modulation generally uses a switching arm and a diode arm. Such modulation is equivalent to a boost cycle in both the positive half cycle and the negative half cycle of the AC power supply, so that the output voltage is higher than the input voltage. This method can theoretically use fewer devices and may achieve higher conversion efficiency and better performance. With the modified totem-pole modulation methods of certain embodiments of this invention, in the positive half line cycle, S₄ keeps ON and S₂ acts as the main switch. In the negative half line cycle, S₂ keeps ON and S₄ acts as the main switch. As a result, there is no duty cycle jumping and no switching loss in the modulation methods of certain embodiments of this invention.

### AC to DC Mode

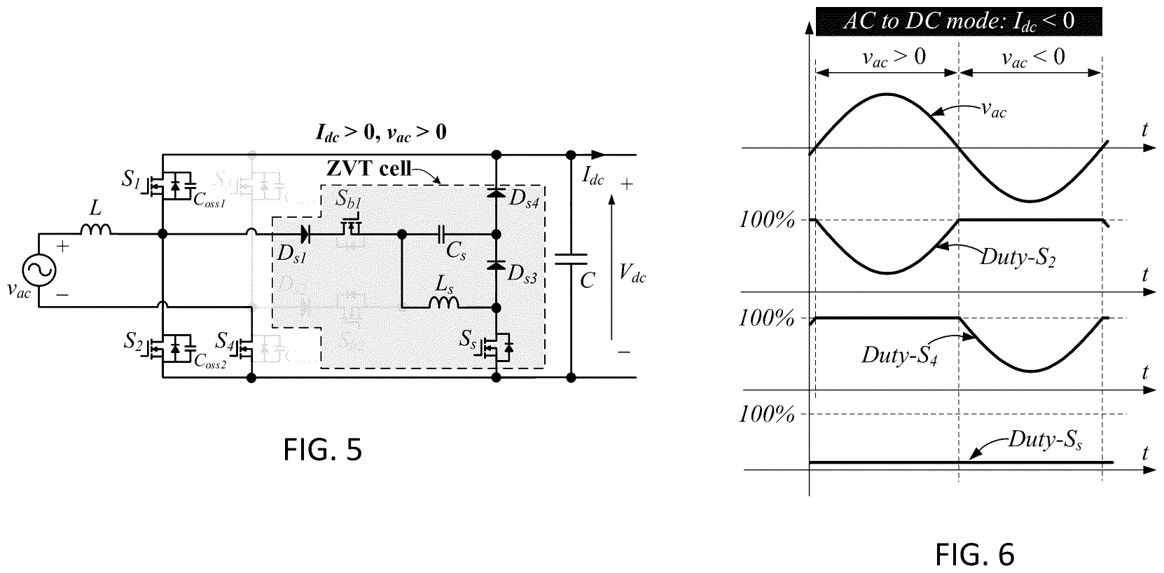

FIGS. 5 and 6 relate to the operation and waveforms of the AC to DC mode of the converter with (I_{dc}>0) and v_{ac}>0: S₄ and S_{b1} are ON, while and S₃ and S_{b2} are OFF during the half positive cycle of v_{ac}. S₂ is the main switch, S₁ is turned ON and OFF complementarily with S₂ as a synchronous switch. Sₛ turns ON a short interval before main switch S₂ turns ON, and Sₛ turns OFF simultaneously with S₂ turning ON. In general, the duration of turn-ON interval of Sₛ is about several hundred nano seconds.

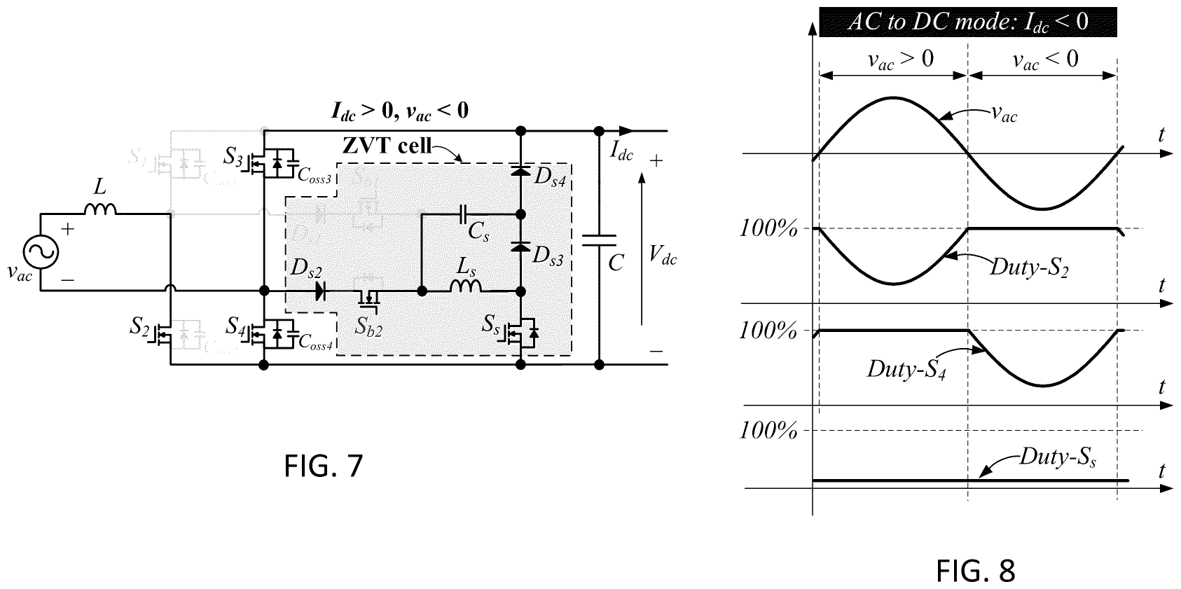

FIGS. 7 and 8 relate to the operation and waveforms of the AC to DC mode of the converter with (I_{dc}>0) and v_{ac}<0: S₂ and S_{b2} are ON, while and S₁ and S_{b1} are OFF during the half negative cycle of v_{ac}. S₄ is the main switch, S₃ is turned ON and OFF complementarily with S₄ as a synchronous switch. Sₛ turns ON a short interval before main switch S₄ turning ON, and Sₛ turns OFF simultaneously with S₄ turning ON. In general, the duration of turn-ON interval of Sₛ is about several hundred nano seconds.

### DC to AC mode

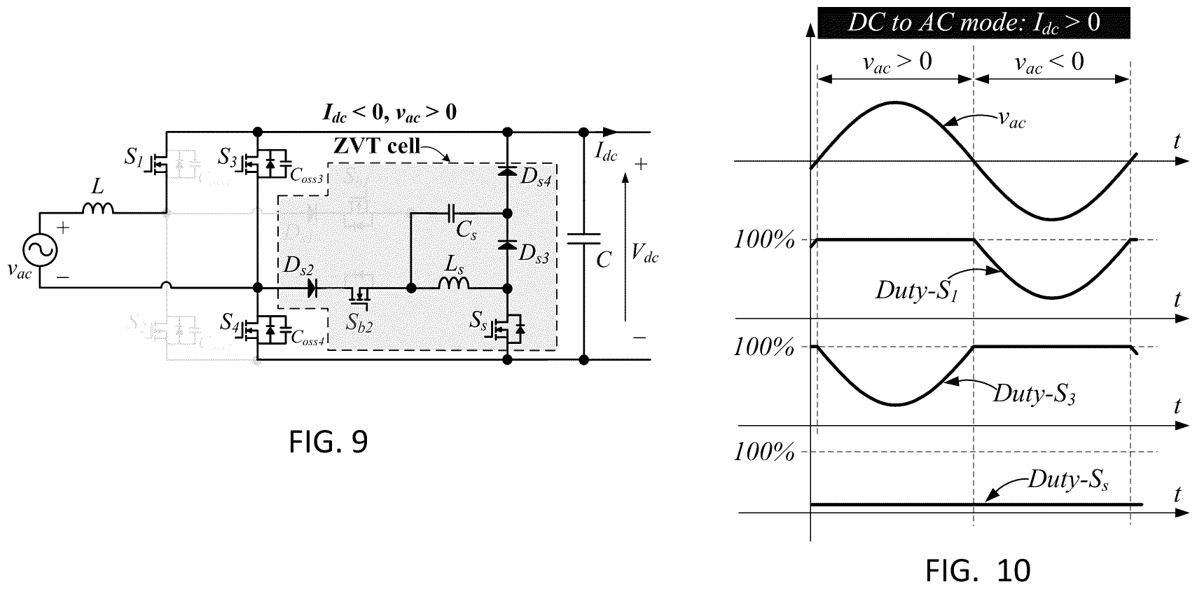

FIGS. 9 and 10 relate to the operation and waveforms of the DC to AC mode of the converter with (I_{dc}<0) and v_{ac}>0: S₁ and S_{b2} are ON, while and S₂ and S_{b} are OFF during the half positive cycle of v_{ac}. S₄ is the main switch, S₃ is turned ON and OFF complementarily with S₄ as a synchronous switch. Sₛ turns ON a short interval before main switch S₄ turning ON, and Sₛ turns OFF simultaneously with S₄ turning ON. In general, the duration of turn-ON interval of Sₛ is about several hundred nano seconds.

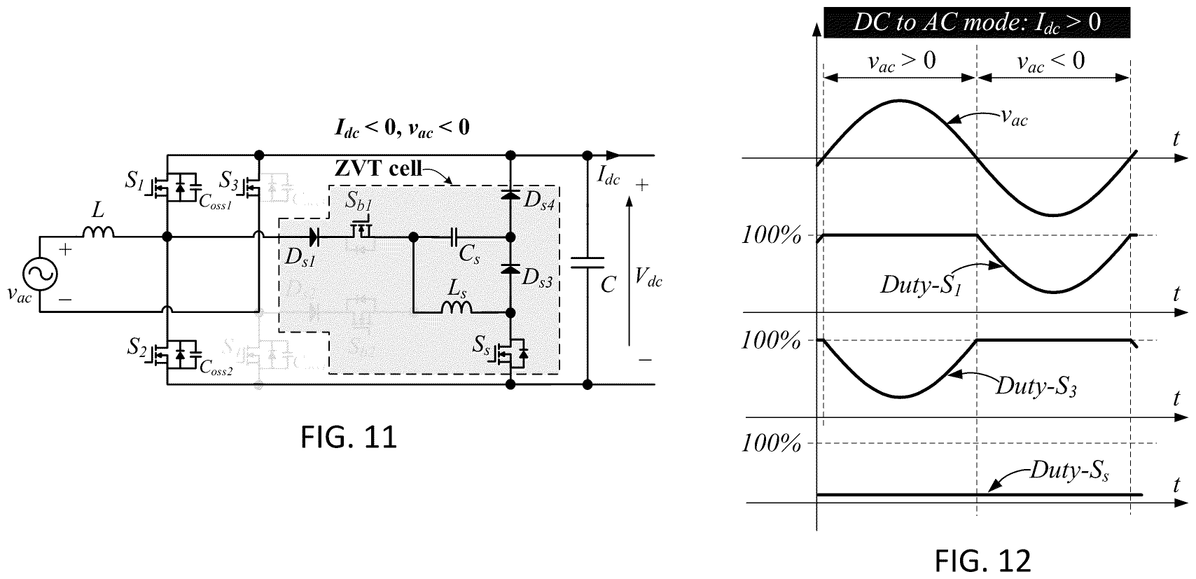

FIGS. 11 and 12 relate to the operation and waveforms of the DC to AC mode of the converter with (I_{dc}<0) and v_{ac}<0: S₃ and S_{b1} are ON, while and S₄ and S_{b2} are OFF during half negative cycle of v_{ac}. S₂ is the main switch, S_{I} is turned ON and OFF complementarily with S₂ as a synchronous switch. Sₛ turns ON a short interval before main switch S₂ turns ON, and Sₛ turns OFF simultaneously with S₂ turning ON. In general, the duration of turn-ON interval of Sₛ is about several hundred nano seconds.

### Magnetic Integration in Onboard Charger Application

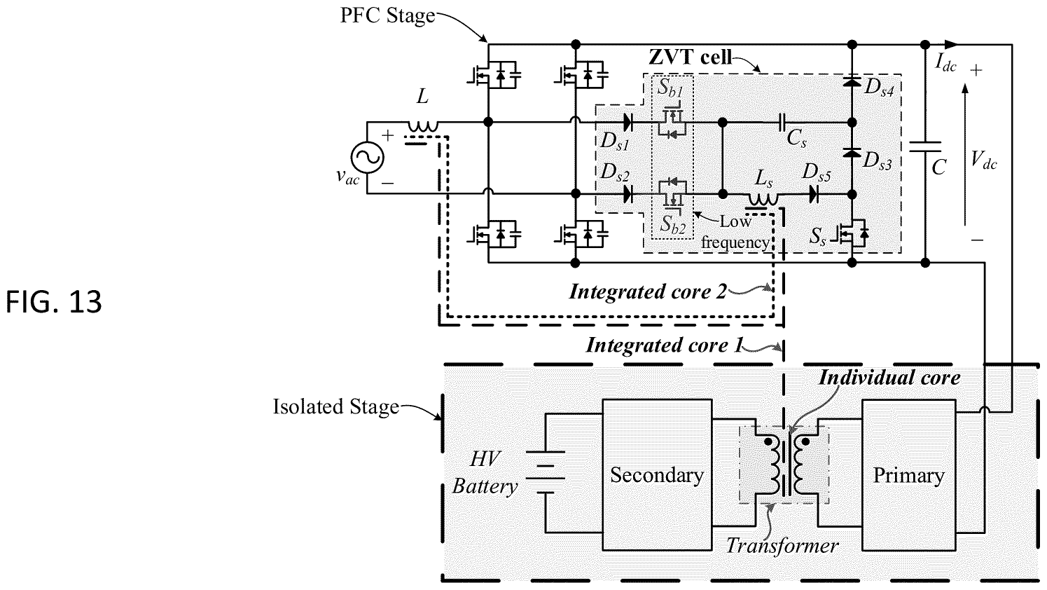

An onboard charger typically includes two stages: Power Factor Correction (PFC) stage, and Isolated stage. Certain embodiments of the bi-directional ZVT AC/DC converters (e.g., FIG. 13) act as a PFC stage, and its PFC choke (L) and ZVT inductor (Ls) are sharing two magnetic cores which are Integrated core 1 and Integrated core 2. In addition, the Integrated core 1 is also shared with the transformer of the isolated stage converter.

### Operation

The operation of a bi-directional ZVT AC/DC converter embodiment of this invention is shown with respect to FIG. 4.

(1) In this embodiment, high switching frequency mosfet Sₛ: turns ON a short period of time before main switch S₂ or S₄ turn ON, and Sₛ turns OFF simultaneously with main switch S₂ or S₄ turning ON. Sₛ turning ON provides a current pathway to charge snubber inductor Lₛ and then discharge the energy stored in the parasitic capacitors of the main switch, Cₒₛₛ₂ and Cₒₛₛ₄, providing soft switching turn on for the main switch S₂ and S₄.

(2) Two low switching frequency mosfet or two insulated-gate bipolar transistors: S_{b1} is used to prevent the unexpected current conducted from V_{ac} through S₁ to other ZVT cell components during DC to AC mode. In the same way, S_{b2} is used to prevent the unexpected current conducted from V_{dc} through S₃ to other ZVT cell components during DC to AC mode.

(3) Dₛ₁ and Dₛ₂ and Dₛ₅ are used to prevent the reverse current conducted through the snubber inductor Lₛ.

(4) Dₛ₃ and Dₛ₄ is used to conduct the snubber inductor current after snubber switch Ss turning OFF, preventing the voltage spike which damages snubber switch Sₛ.

(5) Snubber capacitor Cₛ provides additional capacitance for main switch S₂, S₄, and snubber switch Sₛ during their turn-off interval, which will reduce their turn-off loss.

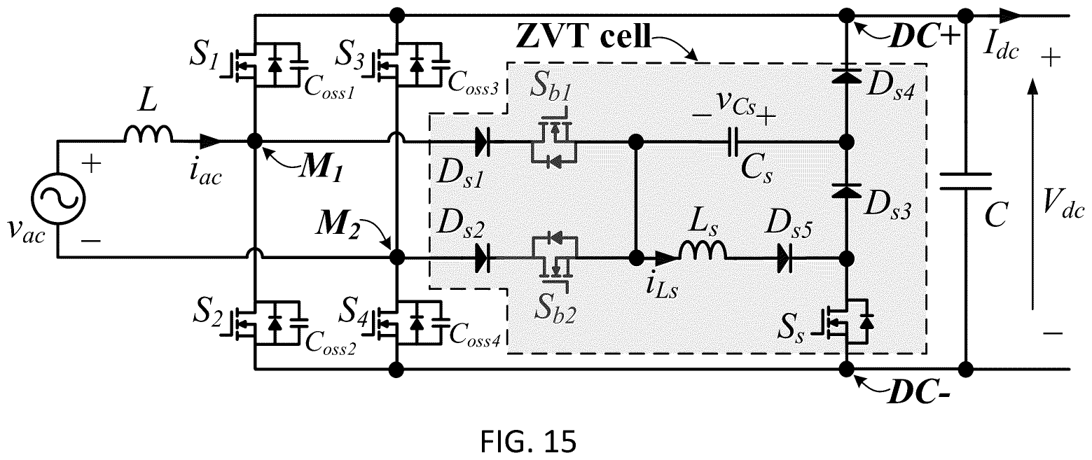

FIG. 15 illustrates how components of certain embodiments of this invention interact. The ZVT cell is integrated into the main AC/DC converter through 4 terminals M₁, M₂, DC+, and DC−. In the main circuit, terminal M₁ is the midpoint of leg S₁-S₂; terminal M₂ is the midpoint of leg S₃-S₄; terminal DC+ is the output positive; and terminal DC− is the output negative. In the ZVT cell, M₁ is the anode of diode Dₛ₁; M₂ is the anode of diode Dₛ₂; DC+ is the cathode of diode Dₛ₄; DC− is the Source of snubber switch Sₛ. The cathode of Dₛ₁ is connected to the Drain of low frequency mosfet S_{b1}; the cathode of Dₛ₂ is connected to drain of low frequency mosfet S_{b2}; the sources of two low frequency mosfets S_{b1} and S_{b2} are connected together and are connected with one terminal of snubber capacitor Cₛ and one terminal of snubber inductor Lₛ; the other terminal of snubber inductor Lₛ is connected to the anode of diode Dₛ₅; the other terminal of snubber capacitor Cₛ is connected to the anode of diode Dₛ₄ and cathode of diode Dₛ₃; the cathode of diode Dₛ₅ and anode of diode Dₛ₃ and the Drain of snubber switch Sₛ are connected together.

### Certain Embodiments Further Facilitating Soft Switching

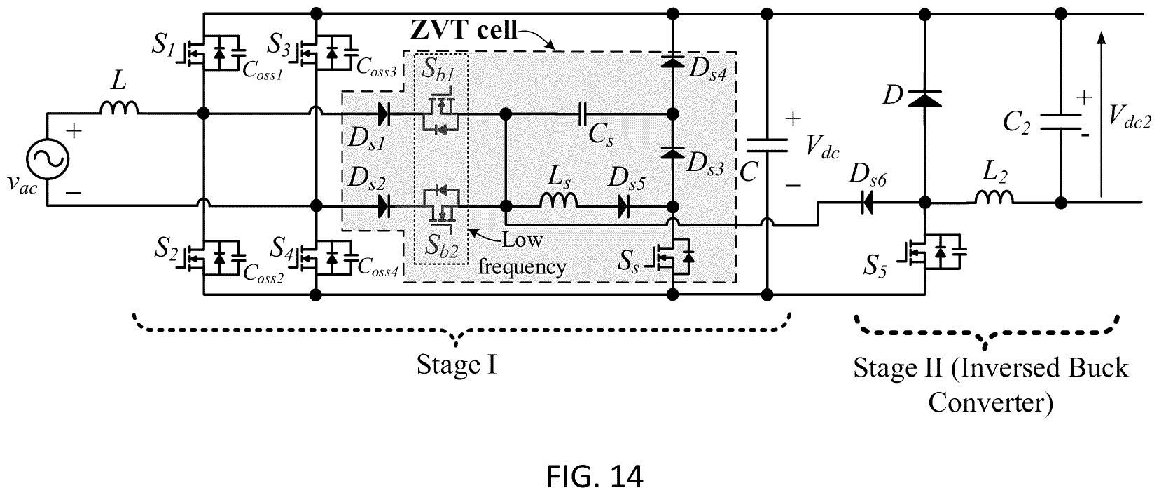

In certain preferred embodiments the ZVT cell can be enhanced to facilitate soft switching for an additional stage. An example of these embodiments is shown in FIG. 14 and they comprise the inclusion of at least one more diode. For example, in an arrangement where an inverse buck converter is serially connected with a bidirectional AC/DC converter, by integrating only an additional diode, labeled Dₛ₆, with its anode attached to the junction between switch S₅and diode D in the inverse buck converter, and its cathode linked to the junction of the snubber inductor Lₛ and the snubber capacitor Cₛ, this enhanced ZVT cell effectively achieves soft switching for both the switch S₅ and diode D.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A zero voltage transient cell for integrating in devices, the zero voltage transient cell comprising:
(a) one high switching frequency mosfet, which switches on before two main switches and off simultaneously with the two main switches, the high switching frequency mosfet providing a current pathway to an inductor;
(b) two low switching frequency mosfets or two insulated-gate bipolar transistors, which are used to prevent current conducted from other components during DC to AC mode;
(c) four diodes, which are used to prevent reverse current from the inductor and voltage spikes;
(d) the capacitor, which is used to provide additional capacitance for the two main switches;
(e) the inductor, which is used as a current storage device to keep current flowing;
wherein the zero voltage transient cell is capable of providing soft switching for the devices it is integrated in.

2. A zero voltage transient cell for integrating in devices, the zero voltage transient cell comprising:
(a) one high switching frequency mosfet, which switches on before two main switches and off simultaneously with the two main switches, the high switching frequency mosfet providing a current pathway to an inductor;
(b) two low switching frequency mosfets or two insulated-gate bipolar transistors, which are used to prevent current conducted from other components during DC to AC mode;
(c) four diodes, which are used to prevent reverse current from the inductor and voltage spikes;
(d) the capacitor, which is used to provide additional capacitance for the main switches;
(e) the inductor, which is used as a current storage device to keep current flowing;
(f) one additional diode in series with the inductor, which is used to prevent reverse current from the inductor and voltage spikes; and
wherein the zero voltage transient cell is capable of providing soft switching for the devices it is integrated in.

3. A bi-directional AC/DC converter having switching, the AC/DC converter comprising a zero voltage transient cell, the zero voltage transient cell comprising:
(a) one high switching frequency mosfet, which switches on before two main switches and off simultaneously with the two main switches, the high switching frequency mosfet providing a current pathway to an inductor;
(b) two low switching frequency mosfets or two insulated-gate bipolar transistors, which are used to prevent current conducted from other components during DC to AC mode;
(c) four diodes, which are used to prevent reverse current from the inductor and voltage spikes;
(d) the capacitor, which is used to provide additional capacitance for the main switches;
(e) the inductor, which is used to provide additional capacitance for the main switches; and
wherein there is no duty cycle jumping and the zero voltage transient cell provides soft switching for all of the switches of the bi-directional AC/DC converter with no switching loss.

4. A bi-directional AC/DC converter, the AC/DC converter having switching, the AC/DC converter comprising a zero voltage transient cell, the zero voltage transient cell comprising:
(a) one high switching frequency mosfet, which switches on before two main switches and off simultaneously with the two main switches, the high switching frequency mosfet providing a current pathway to an inductor;
(b) two low switching frequency mosfet or two insulated-gate bipolar transistors, which are used to prevent current conducted from other components during DC to AC mode;
(c) four diodes, which are used to prevent reverse current from the inductor and voltage spikes;
(d) the capacitor, which is used to provide additional capacitance for the main switches;
(e) the inductor, which is used to provide additional capacitance for the main switches;
(e) one additional diode in series with the inductor to prevent reverse current from the inductor and voltage spikes; and
wherein there is no duty cycle jumping and the zero voltage transient cell provides soft switching for all of the switches of the bi-directional AC/DC converter with no switching loss.

5. A method of modulating the converting of AC to DC and DC to AC with a bi-directional AC/DC converter with switching, the method comprising:
(1) converting AC to DC by (a) inputting AC to the bi-directional AC/DC converter comprising a zero voltage transient cell, the zero voltage transient cell comprising (i) one high switching frequency mosfet, (ii) two low switching frequency mosfet or two insulated-gate bipolar transistors, (iii) four diodes, (iv) one capacitor; and (v) one inductor; and (b) outputting DC, wherein the converting of AC to DC causes no duty cycle jumping and no switching loss in the bi-directional AC/DC converter; and
(2) converting DC to AC by (a) inputting DC to the bi-directional AC/DC converter comprising a zero voltage transient cell, the zero voltage transient cell of part (1); and
(b) outputting AC, wherein the converting of DC to AC causes no duty cycle jumping and no switching loss in the bi-directional AC/DC converter.

6. A method of modulating the converting of AC to DC and DC to AC with a bi-directional AC/DC converter with switching, the method comprising:
(1) converting AC to DC by (a) inputting AC to the bi-directional AC/DC converter comprising a zero voltage transient cell, the zero voltage transient cell comprising (i) one high switching frequency mosfet, (ii) two low switching frequency mosfet or two insulated-gate bipolar transistors, (iii) four diodes, (iv) one capacitor; (v) one inductor, and (vi) one additional diode in series with the inductor; and (b) outputting DC, wherein the converting of AC to DC causes no duty cycle jumping and no switching loss in the bi-directional AC/DC converter; and
(2) converting DC to AC by (a) inputting DC to the bi-directional AC/DC converter comprising a zero voltage transient cell, the zero voltage transient cell of part (1) and (b) outputting AC, wherein the converting of DC to AC causes no duty cycle jumping and no switching loss in the bi-directional AC/DC converter.

7. A vehicle onboard charger comprising a bi-directional AC/DC converter with switching, the bi-directional AC/DC converter comprising a zero voltage transient cell, the zero voltage transient cell comprising (i) one high switching frequency mosfet, (ii) two low switching frequency mosfet or two insulated-gate bipolar transistors, (iii) four diodes, (iv) one capacitor; and (v) one inductor, and wherein the converting of AC to DC and DC to AC causes no duty cycle jumping and no switching loss in the bi-directional AC/DC converter.

8. A vehicle onboard charger comprising a bi-directional AC/DC converter with switching, the bi-directional AC/DC converter comprising a zero voltage transient cell, the zero voltage transient cell comprising (i) one high switching frequency mosfet, (ii) two low switching frequency mosfet or two insulated-gate bipolar transistors, (iii) four diodes, (iv) one capacitor; (v) one inductor; and (vi) one additional diode in series with the inductor, and wherein the converting of AC to DC and DC to AC causes no duty cycle jumping and no switching loss in the bi-directional AC/DC converter.
